(19) United States
(12) Patent Application Publication
(10) Pub. No.: US 2013/0008617 A1
(43) Pub. Date: Jan. 10, 2013

(54) UTILITY SCREEN AND ORGANIZER

(76) Inventor: Frank RIVERA, New York, NY (US)

(21) Appl. No.: 13/176,130

(22) Filed: Jul. 5, 2011

(51) Int. Cl. E06B 9/00

(52) U.S. Cl. 160/127; 40/584

(57) ABSTRACT

A utility screen and organizer comprises at least one panel and at least two posts attached at opposite ends of the at least one panel. The utility screen may be provided with one or more accessories attached or removably attachable to a panel or post. The utility screen may be configured to provide privacy, organization, convenience, protection from the elements, and/or advertising space.

### TECHNICAL FIELD

This disclosure relates to utility screens generally comprised of a plurality of rigid posts and flexible panels secured between the posts. The utility screens of the present disclosure may be used for privacy, weather or sun shielding, advertising or promotional campaigns, organization, and/or storage.

### DESCRIPTION OF RELATED ART

Many people enjoy spending time outdoors as a leisure activity. Whether at the beach, on a lawn, at a picnic, at a camp site, etc., outdoor leisure activities often center around a particular area on a landscape. For example, a picnic in the park may center around a nice patch of grass to lay down a blanket or a day at the beach may center around a spot to put chairs, towels or a cooler. However, nature and crowds do not always cooperate with one's idea of an ideal outdoor experience.

For example, at a crowded beach, possible annoyances can include strangers walking by and kicking sand onto your towel or belongings, a football landing too close to your chair from a nearby game, wind driven sand, the sun's hot rays, etc. As another example, at a picnic in the park, other possible annoyances include animals (wild or pets) coming too close to the food, other people setting up their belongings too close for comfort, etc.

Of course, outdoor activities also sometimes require keeping pets or small children close to their caretakers or toys or other articles within a confined area. Privacy may also be a concern, for example if one wishes to sunbathe privately in a public park.

Prior attempts at keeping undesirable elements (natural or people) away from one's personal area have been suggested, as have attempts at keeping pets or children from wandering away. However, these previous attempts often required lengthy and/or complicated set-up procedures, were bulky and not easy to transport, were not sturdy enough, etc. Thus, there exists a need for an improved utility screen generally adapted for outdoor use.

### SUMMARY

In an aspect of the present disclosure, a utility screen includes at least one panel and at least two posts attached to the panel at opposite ends. According to an embodiment, the utility screen may be provided with one or more accessory attachment members defining a plurality of accessory attachment locations on either the panel or the posts. Accessories attachable to the utility screen can take many forms and are not limited in this way. Accessories attachable to the utility screen may include an accessory attachment complimentary to the accessory attachment member.

In another aspect of the resent disclosure, a utility screen comprises at least two posts, a panel comprising an attachment at either end thereof for attaching to a post and an accessory configured with a removable attachment for attaching to a top portion of one of the at least two posts.

In still another aspect of the present disclosure, a utility screen includes at least two posts, at least one panel comprising an attachment at either end thereof for attaching to the at least two posts and at least one accessory attachable to at least one of a post and the at least one panel. In yet another aspect, a utility screen comprises at least two posts and at least one panel comprising an attachment at either end thereof for attaching to the at least two posts. The at least one panel comprises a back portion, a front top portion attached to the back portion and a front bottom portion attached to the back portion, wherein the front top portion and the front bottom portion are positionable with respect to each other so as to define an inner compartment bounded by the back portion, front top portion and front bottom portion.

### BRIEF DESCRIPTION OF THE DRAWINGS

The above mentioned and other aspects, features and advantages can be more readily understood from the following detailed description with reference to the accompanying drawings wherein:

FIG. 1A and 1B are front views of utility screens according to different exemplary embodiments of the present disclosure;

FIG. 2 is a front view of a panel according to another exemplary embodiment of the present disclosure;

FIG. 3 illustrates a post according to yet another exemplary embodiment of the present disclosure;

FIGS. 4A-4F illustrate panel to post attachments according to various exemplary embodiments of the present disclosure;

FIGS. 5A-5F illustrate utility screen configurations according to various exemplary embodiments of the present disclosure;

FIG. 6 is a front view of a utility screen according to still another exemplary embodiment of the present disclosure;

FIG. 7 is a partial front view of a utility screen according to still another exemplary embodiment of the present disclosure;

FIG. 8 is a partial front view of a utility screen according to still another exemplary embodiment of the present disclosure;

FIG. 9 is a partial front view of a utility screen according to still another exemplary embodiment of the present disclosure;

FIGS. 10A and 10B are a perspective and rear view, respectively, of a utility screen according to another exemplary embodiment of the present disclosure;

FIGS. 11A and 11B are a front and cross sectional side view, respectively, of a utility screen according to another exemplary embodiment of the present disclosure;

FIGS. 11C and 11D are a front and cross sectional side view, respectively, of a utility screen according to another exemplary embodiment of the present disclosure;

FIG. 12 is a front view of a utility screen according to still another exemplary embodiment of the present disclosure; and

FIG. 13 is a front view of a utility screen according to still another exemplary embodiment of the present disclosure.

### DETAILED DESCRIPTION

Utility screen apparatuses are described herein, with reference to examples and exemplary embodiments. Specific terminology is employed in describing examples and exemplary embodiments. However, the disclosure of this patent specification is not intended to be limited to the specific terminology so selected and it is to be understood that each specific element includes all technical equivalents that operate in a similar manner.

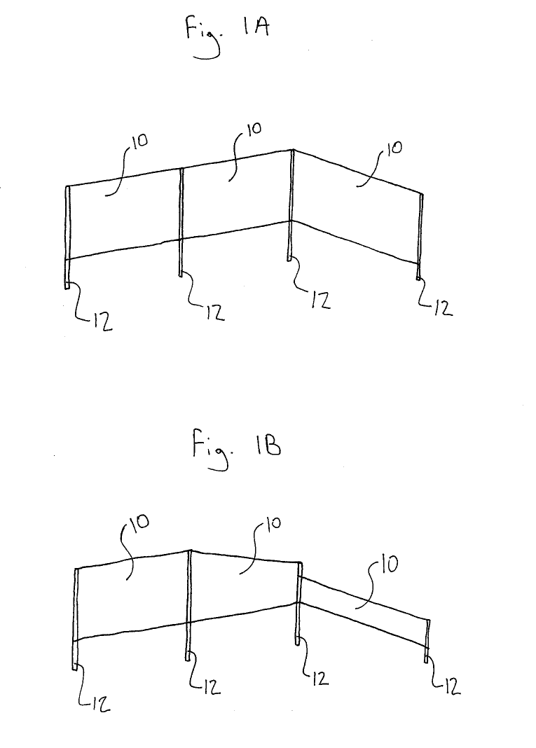

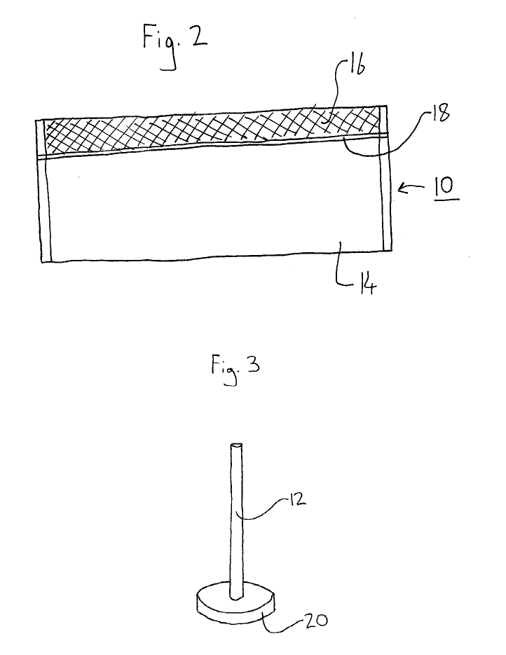

In an aspect of the present disclosure, shown in FIGS. 1A and 1B, a utility screen includes one or more panels 10 and one or more posts 12 secured, for example, at either end of the panel 10. Material choices for the panel 10 are not particularly limited and can include, for example, natural or synthetic fabric, open weave screens (for example window screen type material), rigid or semi-rigid materials (such as plastic, wood, rubber, metal, fiberglass, etc.), flexible plastic films (such as vinyl, etc.), etc. According to an embodiment, the panel may be comprised of one or more rope, string, bar or other member generally run parallel to the ground between posts. Some properties of the panel could include a predetermined level of light blocking, stain resistance, water resistance or water proofing, a predetermined resistivity to wind and/or windblown debris (such as sand, leaves, twigs, etc.), an ability to block visibility in some manner (beyond a predetermined distance, from a predetermined direction, by a predetermined amount, etc.), a predetermined mechanical strength, a predetermined weight per unit area, etc. In yet another example, a panel 10 may provide sound blocking or absorption properties to shield a user from unwanted noise.

The panels 10 may be configured in one or more sizes. The sizes may be uniform throughout, as shown in FIG. 1A, or may include one or more panels with varying sizes, as shown in FIG. 1B. In one preferred embodiment, each panel is between 6 to 20 feet in length and between 20 to 36 inches in height. In another preferred embodiment, the panels 10 are at least 6 feet in height and configured to block visibility through the panel 10 for privacy.

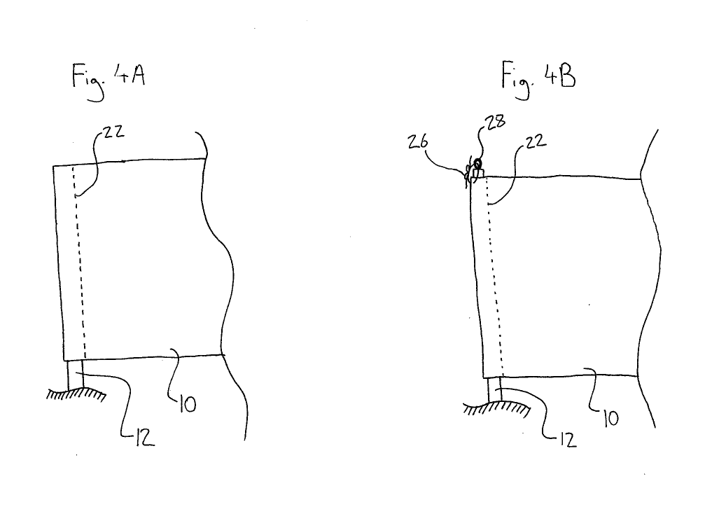

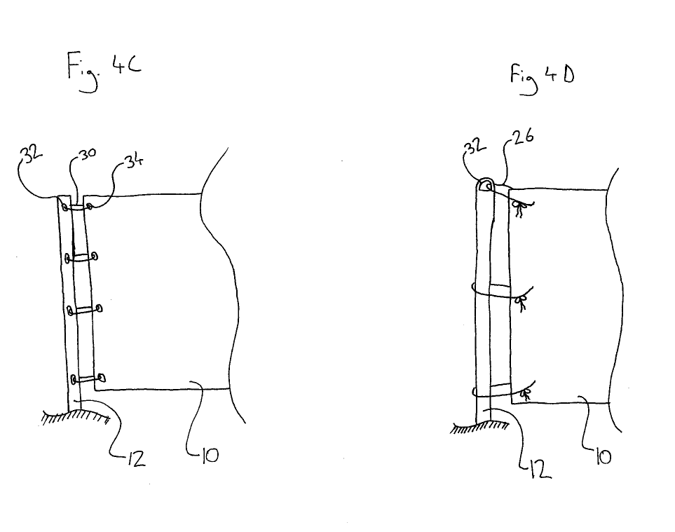

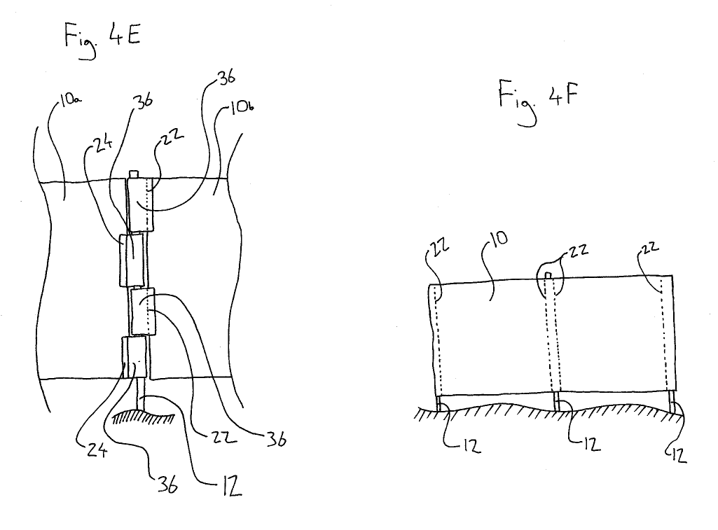

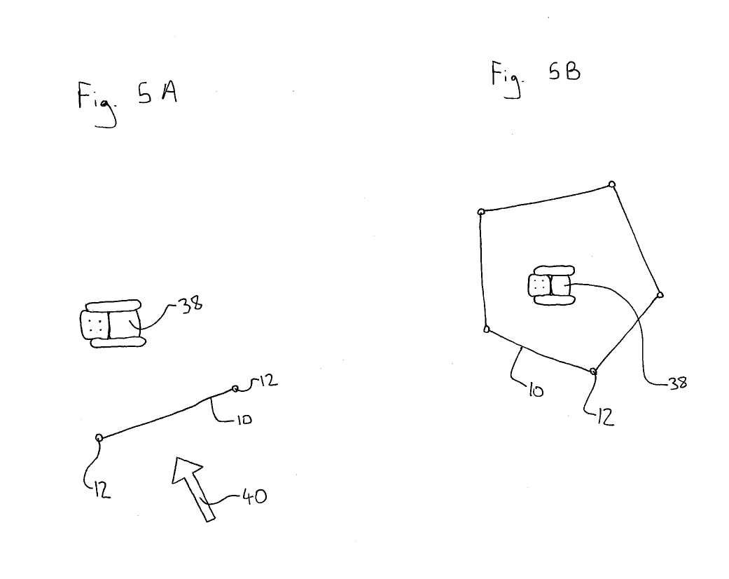

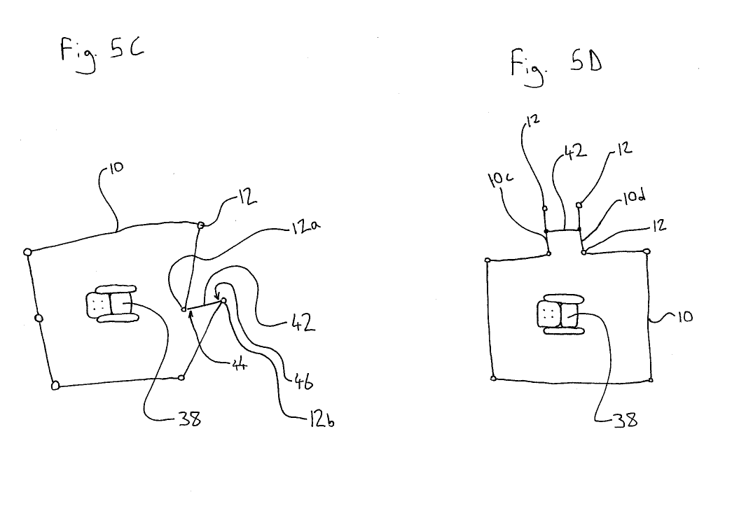

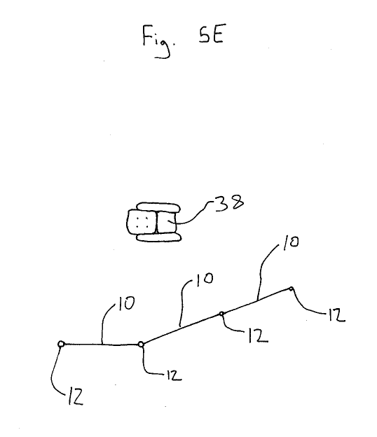

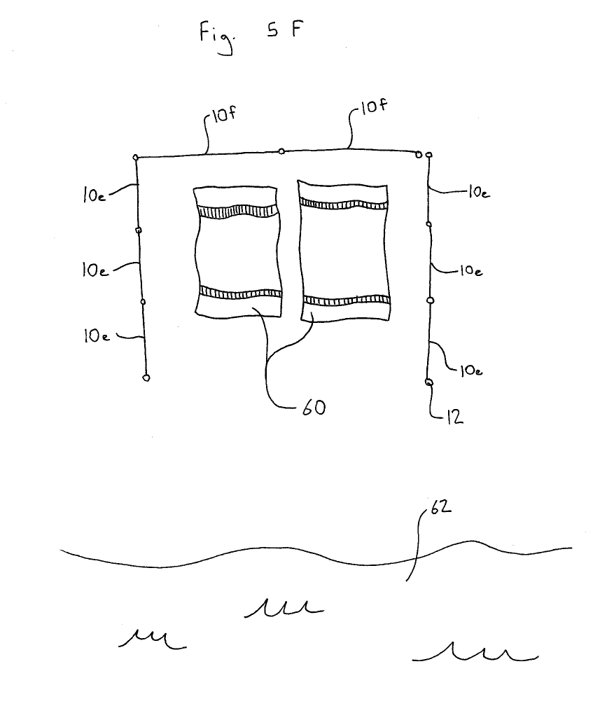

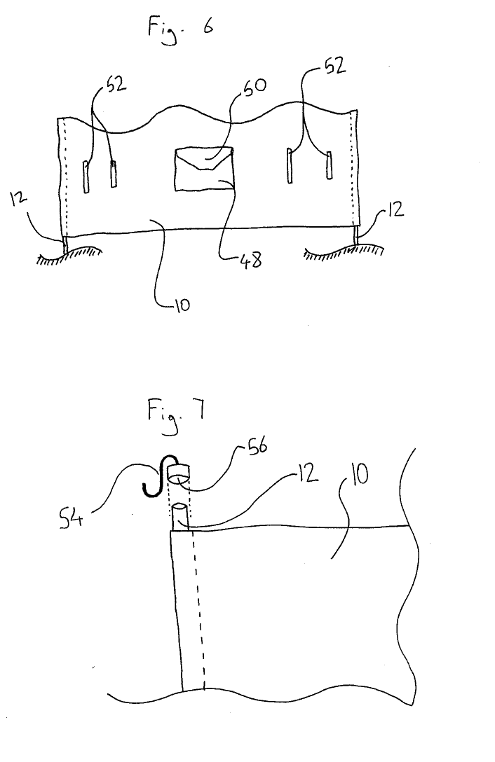

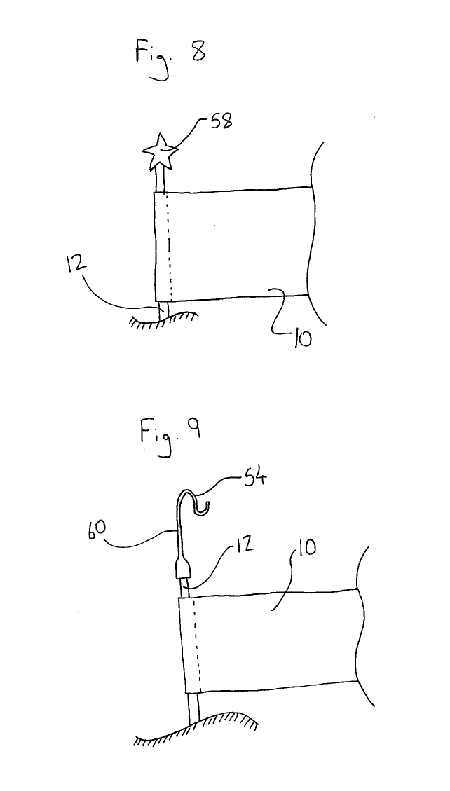

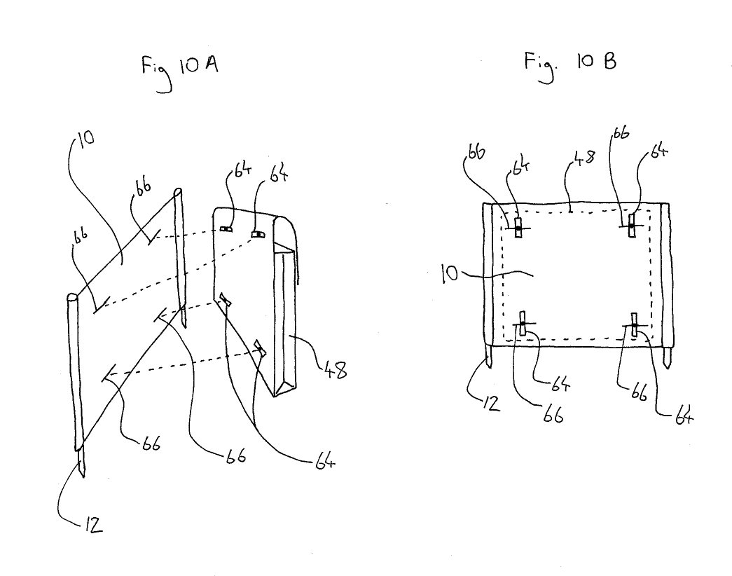

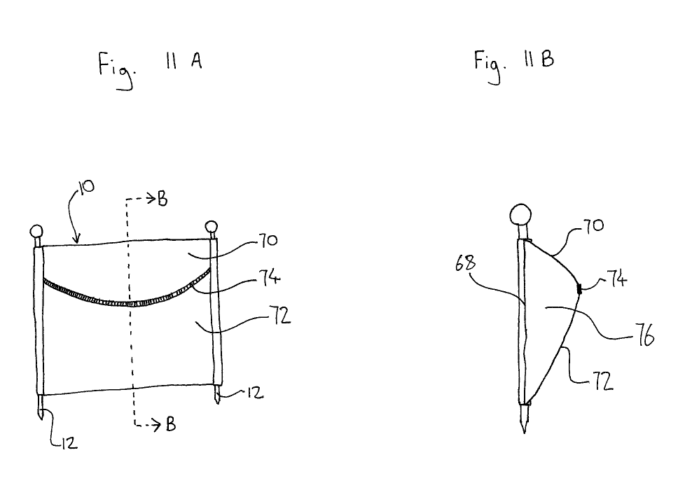

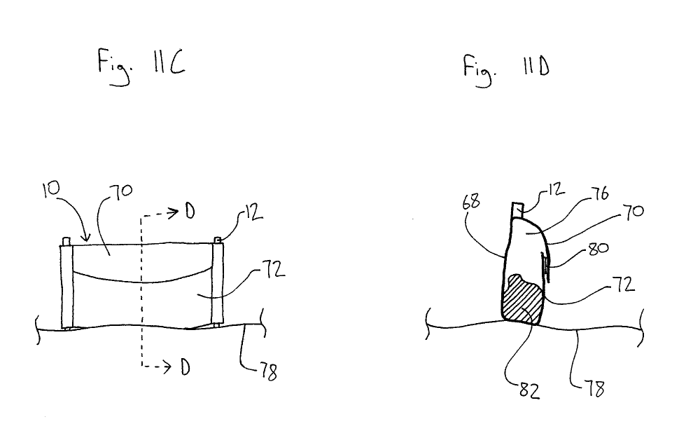

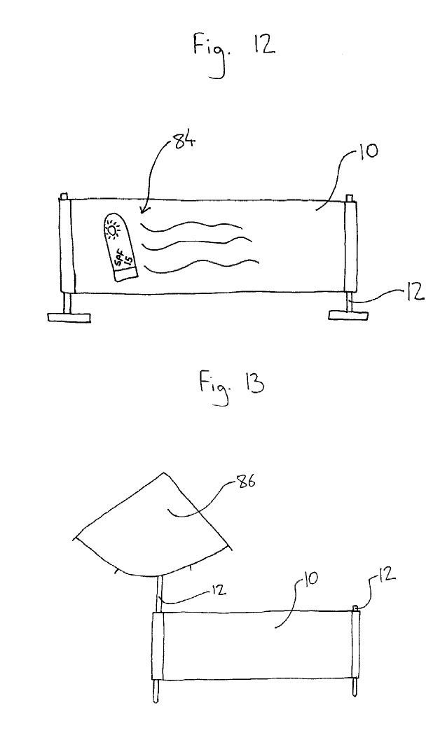

The one or more panels need not be constructed of a single material and may be constructed by using separate parts. For example, as shown in FIG. 2, a panel 10 may be constructed of a lower portion 14 and an upper portion 16. In one example, the lower portion 14 may be made of a lightweight nylon fabric material while the upper portion 16 may be made of a visibly transparent screen material. In the example shown in FIG. 2, the upper portion 16 and lower portion 14 are detachably joined by a fastener 18, shown in FIG. 2 as a hook and loop type fastener. Of course other fasteners may be readily employed including, for example, zippers, string ties, magnetic and/or snap closures, or any combination thereof.

The material for the one or more posts 12 of the utility screen may also be a plurality of different materials, or a combination thereof. For example, posts 12 may be constructed of wood (such as, bamboo, hardwood), plastic (such as, nylon, polypropylene), composite (such as, fiberglass, graphite, carbon fiber), metal, etc. Also, a cross sectional profile of the one or more posts 12 is not restricted. For example, a post 12 may have a solid cross section, a hollow cross section, a patterned cross section (such as an H, I, L, C, D, Y, J or any other shaped profile, or any combination thereof). Generally, the posts 12 are configured to be rigid enough to be inserted into the ground and are resilient enough to withstand a predetermined amount of force without breaking or deforming too much. For example, the posts 12 may be constructed of an appropriate material and appropriately sized so that, for example, a wind gust, stray athletic ball, etc. does not damage the one or more posts 12 or utility screen and does not cause the utility screen to fall over. In another example, described below, the posts 12 may withstand additional weight in addition to simply holding a panel 10 in place. Posts 12 need not be a single member. For example, posts 12 may be formed of several members fixable to one another, for example in a telescoping arrangement or in an arrangement with one end of a post member fitting within an end of an adjacent another post member and being dislocatable therefrom.

A post 12 may be configured not to extend above an upper edge of a panel 10 or may be configured to extend above an upper edge of a panel 10. For example, a post 12 may be configured to extend a predetermined distance above the ground and above a panel 10 so as to keep an article of clothing, a towel or other article hung thereon from contacting the ground.

Generally, the posts 12 may be provided with a lower portion and an upper portion. According to an embodiment, the lower portion of a post 12 may be configured for insertion into the ground while the upper portion may be configured for attachment to one or more panels 10. The lower portion may be configured for easy insertion into the ground. For example, the post may be provided with a sharpened end or a screw end. In the case of a post 12 that includes a lower portion configured to be inserted into the ground, the portion of the post configured to be installed below the surface of the ground may be configured to be long enough or otherwise firmly secured to the ground to resiliently support the utility screen. In one preferred embodiment, the lower portion of a post 12 penetrated the ground to a depth of at least one foot. The post may be configured to be inserted into the ground by hand or with the aid of, for example, a hammer, mallet, or torque applying tool. As an optional additional means for stabilization of the utility panel, a diagonal support rope may be attached to a post 12 or panel 10 and fixed to the ground at a predetermined distance away from the post to add lateral stability to the utility screen.

As another example, shown in FIG. 3, a lower portion of a post 12 may be configured with a base member 20 configured for stably supporting the sake above the ground without necessarily penetrating the ground. For example, a post 12 with a base member 20 may be used on top of a paved or cement surface such as a sidewalk, parking lot, pool deck, etc. In an embodiment, base member 20 may be permanently attached to the post 12 or may be detachable therefrom.

The attachment between the one or more panels 10 and one or more posts 12 may take many forms. FIGS. 4A-4F illustrate several possibilities, although many more are possible. In FIG. 4A, a panel 10 is configured to wrap around a post 12 and is secured to itself, for example by stitching 22, to create a pocket for receiving a post 12. According to an embodiment, a pocket may be closed at the top, as shown in FIG. 4A or may be open at the top, as shown in FIG. 4B. According to another embodiment, a panel may be attached to itself to form the pocket in a permanent way (such as stitching 22) or by a removable fastener (such as a hook and loop type fastener 24, shown in FIG. 4E).

FIG. 4B shows a panel with a means of attachment to the top of a post 12. In the example shown in FIG. 4B, panel 10 includes a tie string 26 configured to be threaded through an eye 28 fixed to the top of post 12 and tied. In this example, the tie string 26 serves to keep the panel from sagging down on a post 12 from its intended position.

In another example, as shown in FIG. 4C, panel 10 is attached to post 12 by a plurality of loops 30 passing through a plurality of holes 32 in the post 12 and a plurality of open grommets 34 in the panel 10. Loops 30 may be permanently or removably attached to the panel 10 and/or the post 12.

In yet another example, panel 10 may be attached to the post 12 by a plurality of tie strings 26, as shown in FIG. 4D. In FIG. 4D, an uppermost tie string 26 is passed through a hole 32 in the post 12 and lower tie strings 26 are simply wrapped around post 12. Of course, any number of the tie strings may be passed through holes 26 in the post or may simply be passed around the post 12, including the uppermost tie string 26. In FIG. 4D, the tie strings 26 are shown being attached to panel 10, although it will be appreciated that tie strings may not be permanently attached to either the panel 10 or the post 12 or may be attached to the panel 10 or the post 12 in any combination.

FIG. 4E shows another example of a panel 10a, 10b configured with one or more tabs 36 wrapped around the post 12. Also shown in FIG. 4E, more than one panel 10a, 10b may be attached to a single post 12. The left panel 10a may be configured with tabs 36 removably wrapped around the post 12, secured with a hook and loop type fastener 24. According to an embodiment, any removable attachment may be used (such as, a zipper, snaps, magnets, tie strings), or, as in the example of the right panel 10b, tabs 36 may be permanently configured, such as by stitching 22 and/or gluing.

FIG. 4F shows a panel supported by more than two posts 12. In the example shown, for example, the panel is attached to a third post 12 by means of a pocket in the panel formed by stitching 22. Any means of attachment can be used, such as a permanent or removable attachment or any combination thereof for the one or more posts 12. Any number of additional posts 12 may be attached to a panel 10 to improve stability, add configuration options, add accessory attachment locations, as further discussed below.

The utility screen of the present disclosure may be adaptively configured according to any situation in which a user chooses to use it. Also, the numbers of panels and posts comprised in a utility screen are not limited. For example, as the number of panels or posts are increased, more configuration options become available. FIGS. 5A-5F show top views of several configuration options, although many more are possible.

In one example, shown in FIG. 5A, a single panel 10 between a pair of posts 12 is configured to block a user's location (depicted generally by a chair 38) from an annoyance direction 40, such as a wind direction, a direction of the sun, a direction of noise, etc.

In another example, shown in FIG. 5B, multiple panels 10 and posts 12 are configured to enclose an area. In this example, the utility screen may be configured to provide privacy from onlookers, to keep pets or small children within the enclosed area, to keep strangers from wandering into a private event, etc.

Of course, as illustrated in FIG. 5C, an area enclosed by the utility screen may be accessed through an entryway, which may or may not be fitted with a gate 42. A gate 42, in the context of the present disclosure may simply be considered another type of panel 10, or an auxiliary panel. Accordingly, the previous descriptions of panels 10 may be applied to a gate 42. For example, a gate 42 may be comprised of a flexible panel 10 that is configured with removably attachable tabs 36 (such as in the example of panel 10a in FIG. 4E) on one side 44 configured to be attached to an adjacent post 12a and on the other side 46 may be permanently or at least temporarily fixed to another adjacent post 12b. In another example, a gate 42 may be a rigid panel 10 hingedly attached to an adjacent post 12b and configured to latch closed against another adjacent post 12a.

In yet another example, shown in FIG. 5D, a gate 42 may be positioned between posts 12 on adjacent panels 10c, 10d. In this example, the gate 42 may be sewn to one panel 10c and removably attached to the other panel 10d (for example, by a zipper, snaps, hook and loop fasteners, etc.).

In still another example, shown in FIGS. 1A and 5E, a utility screen may include a plurality of panels which do not necessarily define an enclosed space.

FIG. 5F shows yet another example of a possible configuration of one or more utility screens. In the example shown in FIG. 5F, an area on a beach is partially enclosed by two utility screens to provide some degree of privacy around users' towels 60. Although shown as two utility screens, of course the configuration shown in FIG. 5F could be adapted to employ one to an infinite number of utility screens. In the example shown, a back portion of a utility screen configuration is formed by two panels 10f each measuring between approximately 20″ and 48″ in length and are positioned to face a body of water 62, such as an ocean, lake or pond. Side portions of the utility screen configuration shown in FIG. 5F are formed by three side panels 10e each, the side panels 10e each measuring between approximately 20″ and 36″ in length and oriented generally perpendicularly to the back panels 10f towards the body of water 62.

In another aspect of the present disclosure, a utility screen may include various accessories that may be integrated into the screen. Accessories may be integrated into a panel, into a post or both. For example, accessories may be permanently attached to a post and/or a panel or may be configured with removable attachment means for temporarily attaching to a post or panel (such as, for example, a tie string, zipper, snaps, hook and loop fastener, magnets, etc.).

In addition, accessories may take many forms. For example, some possible accessories include, but are not limited to, an open or closeable pocket, an insulated pocket, a lockable pocket, a drink holder, a solar charger for converting light to electricity, a chalk board, a white board adapted for use with erasable markers, hooks for hanging items, a battery powered or solar light, etc. As another example, accessories may also serve as safety members. For example, sponge toys or other compliant members may be attached to the top of posts to protect against injury from falling on a post. According to an embodiment, one or more accessories may be attached to the one or more panels and/or one or more posts.

In one example, shown in FIG. 6, a pocket 48 is removably attached to a panel 10. The pocket 48 shown in FIG. 6 has a cover flap 50 to protect contents of the pocket 48 from the environment and also to ensure that contents of the pocket 48 do not inadvertently fall out of the pocket 48. Also, the pocket 48 may be configured to be watertight or at least water resistant. In addition, panel 10 in FIG. 6 is configured with multiple accessory attachment positions. In the example shown, accessory attachment positions are defined by the location of hook and loop fastener strips 52. Of course, it will be appreciated that accessory attachment positions may be refined by any other type of removable attachment means such as, for example, snaps, tie strings, magnets, zippers, and/or any combination thereof. With a plurality of accessory attachment locations, a user is able to select between any available accessory to attach to any available accessory attachment location. Accordingly, a utility screen may be adapted according to the desires of a user for use in different situations. For example, a user spending a day at the beach may desire a first set of accessories attached to a utility screen in a first arrangement, while the same user might desire a second set of accessories attached to the utility screen according to a second arrangement for a family picnic in their back yard.

In another example, a panel may not comprise discrete accessory attachment locations and may instead provide the whole panel 10 or a portion of the panel 10 as an attachment location. For example, a panel 10 may be comprised of a terrycloth material and an accessory may be provided with a hook portion of a hook and loop type fastener. The hook portion on the accessory will readily attach to the terrycloth panel 10 to attach the accessory to the panel 10. For example, a pocket may be configured with a hook portion of hook and loop fastener material and the pocket may be attached to any location and in any orientation to a panel comprised of terrycloth or the loop portion of hook and loop fastener material.

In yet another example, an accessory may be configured for attachment to a post 12, either directly to the post 12 or over the top of a panel's 10 attachment to a post 12. For example, as shown in FIG. 7, a hook 54 is provided with a cap portion 56 configured to receive the top of a post 12.

In still another example, shown in FIG. 8, a compliant accessory 58 is secured to a top of a post 12 to provide a safety measure to prevent serious injury should one fall on the post 12. Such a compliant accessory 58 can take many shapes. In the example shown in FIG. 8, the compliant accessory 58 is configured as a starfish.

In another example, an accessory may include a post extender 60. For example, as shown in FIG. 9, a hook accessory 54 includes a post extender 60 configured to attach to the top of a post 12 for increasing the distance from the ground for the hook 54.

FIGS. 10A and 10B show another example of an accessory, in the form of a pocket 48, configured with attachments complimentary to attachments on a panel 10 for removably attaching the pocket accessory 48 to the panel 10. FIG. 10A shows a perspective view of a pocket 48 before attaching to the panel 10 and FIG. 10B shows a back view of the pocket 48 (hidden from view by the panel 10 but represented by dashed lines) after attachment to the panel). In the example shown in FIGS. 10A and 10B, the pocket 48 is fitted with rotatable toggles 64 which have a generally rectangular shape, although any other shape toggle may also be used. The rotatable toggles 64 are configured to fit through slits 66 in the panel 10. Once through the slits 66 in the panel 10, rotatable toggles 64 are rotated from an orientation generally matching that of the slits 66 (such as horizontal as shown in the example shown in FIG. 10A) to an orientation generally orthogonal to or not matching the orientation of the slits 66 (such as vertical as shown in the example of FIG. 10B). Although FIGS. 10A an 10B show four rotatable toggles 64 per pocket 48, any number of toggles may be used. Also, in contrast with the example shown in FIG. 6, the panel 10 shown in FIGS. 10A and 10B is configured to receive a single pocket 48 or other accessory, although in either example, an accessory could be oriented in a number of different orientations wherever it is attached to the panel 10, such as right side up as shown, upside down, etc.

In another aspect, a panel 10 may itself form a compartment for storing belongings, toys, food, etc. In one example, shown in FIG. 11A and FIG. 11B, a cross section of the utility screen shown in FIG. 11A taken along section BB, a panel consists of a back portion 68, front top portion 70 and front bottom portion 72. A zipper 74 closes the front top portion 70 to front bottom portion 72, defining an inner compartment 76.

In another example, shown in FIG. 11C and 11D, a cross section of the utility screen shown in FIG. 11C taken along section DD, a panel consists of a back portion 68, front top portion 70 and front bottom portion 72, similar to the example shown in FIGS. 11A and 11B. In this example, however, the interior compartment 76 rests on the ground 78 and the front top portion of the panel 10 is a flap which overlaps the front bottom portion 72 and is secured thereto by a hook and loop fastener 80. In this example, the contents 82 of inner compartment 76 help to provide stability to the utility screen. In one example, an interior compartment may be made watertight by using waterproof materials for the various portion of the panel 10 and/or by configuring a closure of the compartment 76 to be watertight.

In another aspect, a panel 10 may be configured with lettering or other graphic artwork, a solid color, may include a pattern or design, or any combination thereof. For example, a panel may be used as advertisement or promotional item for a particular brand, sports team, restaurant, etc. In another example, a panel 10 may be configured with a mural or other aesthetically pleasing artwork. In one particular example, shown in FIG. 12, a panel 10 contains an advertisement 84 for a brand of sunscreen.

In another aspect, a post 12 included with a utility screen may be configured with a function other than just supporting a panel 10. For example, FIG. 13 shows a post 12 with an integrally formed umbrella 86. As another example, an umbrella 86 may be an example of an accessory that may be attached a post 12 or a panel 10.

In addition, the embodiments and examples above are illustrative, and many variations can be introduced on them without departing from the spirit of the disclosure or from the scope of the appended claims. For example, elements and/or features of different illustrative and exemplary embodiments herein may be combined with each other and/or substituted for each other within the scope of this disclosure.

What is claimed is:

1. A utility screen comprising:
at least two posts;
at least one panel comprising an attachment at either end thereof for attaching to the at least two posts;
one or more accessory attachment members defining one or more accessory attachment locations on the at least one panel; and
at least one accessory provided with an accessory attachment complimentary to the one or more accessory attachment members.

2. The utility screen of claim 1, wherein the accessory attachment of the at least one panel and the at least one accessory provide for removable attachment between the at least one panel and the at least one accessory.

3. The utility screen of claim 1, wherein the at least one accessory is a pocket.

4. The utility screen of claim 3, wherein the pocket is insulated.

5. The utility screen of claim 3, wherein the pocket includes a closure at a top portion thereof.

6. The utility screen of claim 5, wherein the closure is a zipper and includes a lock receiving portion for receiving a lock for securing the closure in a closed position.

7. The utility screen of claim 3, wherein the pocket includes a closure flap.

8. The utility screen of claim 7, wherein the closure flap is provided with a lock receiving portion for receiving a lock for securing the closure flap in a closed position.

9. The utility screen of claim 1, wherein the at least one accessory is a solar panel configured to convert light into electricity.

10. The utility screen of claim 1, further comprising a hook accessory configured to attach to a top portion of one of the at least two posts.

11. The utility screen of claim 10, wherein the hook accessory includes a post extension portion for distancing a hook portion of the hook accessory from the top portion of the post.

12. The utility screen of claim 1, wherein the utility screen comprises at least three posts and the panel includes at least one post receiving portion between the ends of the at least one panel for receiving a post.

13. The utility screen of claim 1, further comprising at least one auxiliary panel and at least one auxiliary post, wherein
the auxiliary panel is provided with an attachment at a first end thereof for attaching to at least one of the panel and one of the at least two posts and
the auxiliary panel is provided with an attachment at a second end, opposite the first end, for attaching to the auxiliary post.

14. The utility screen of claim 1, further comprising a gate removably attachable between one of a panel and a post and one of another panel and another post.

15. A utility screen comprising:
at least two posts;
a panel comprising an attachment at either end thereof for attaching to a post;
an accessory configured with a removable attachment for attaching to a top portion of one of the at least two posts.

16. The utility screen of claim 15, further comprising a hook accessory configured to attach to a top portion of one of the at least two posts.

17. The utility screen of claim 16, wherein the hook accessory includes a post extension portion for distancing a hook portion of the hook accessory from the top portion of the post.

18. The utility screen of claim 15, wherein the accessory includes a compliant portion configured to mitigate injury from falling on the one of the at least two posts.

19. The utility screen of claim 15, wherein the accessory is a drink holder.

20. The utility screen of claim 15, wherein the accessory is a light.

21. A utility screen comprising:
at least two posts;
at least one panel comprising an attachment at either end thereof for attaching to the at least two posts; and
at least one accessory attachable to at least one of a post and the at least one panel.

22. The utility screen of claim 21, wherein the at least one panel includes an advertisement thereon.

23. A utility screen comprising:
at least two posts; and
at least one panel comprising an attachment at either end thereof for attaching to the at least two posts, wherein
the at least one panel comprises a back portion, a front top portion attached to the back portion and a front bottom portion attached to the back portion and
the front top portion and the front bottom portion are positionable with respect to each other so as to define an inner compartment bounded by the back portion, front top portion and front bottom portion.

24. The utility screen of claim 23, wherein panel further comprises an inner compartment attachment configured to attach the front top portion of the at least one panel to the front bottom portion of the at least one panel.
